(19) United States
(12) Patent Application Publication
(10) Pub. No.: US 2024/0163644 A1
(43) Pub. Date: May 16, 2024

(54) A PROXIMITY SENSING SYSTEM

(71) Applicant: Eaton Intelligent Power Limited, Dublin 4 (IE)

(72) Inventors: Daniel ZUCCHETTO, Dublin (IE); Padhraig RYAN, Keatingstown (IE)

(21) Appl. No.: 18/552,111

(22) PCT Filed: Mar. 29, 2021
(86) PCT No.: PCT/EP2021/058164

§ 371 Date: Sep. 22, 2023

(51) Int. Cl. H04W 4/029; G01S 11/06; H04W 52/02

(52) U.S. Cl. CPC H04W 4/029; H04W 52/0254; G01S 11/06

(57) ABSTRACT

An electronic device comprises a motion sensor for monitoring the motion of the electronic device and a wireless communication system for communication with one or more others electronic devices of a proximity sensing system. The method comprises: scanning for communication signals transmitted to the wireless communication system from another electronic device; transmitting communication signals from the wireless communication system for detection by another electronic device; and when one or more communication signals are received from another electronic device, determining a proximity of users of the respective electronic devices based on the one or more received communications signals. The method further comprises optimising power usage of the wireless communication system by: detecting a change of the motion of the electronic device from a first motion state to a second motion state; and modifying the transmission of communication signals from the wireless communication system in dependence on the detected change.

### TECHNICAL FIELD

The present disclosure relates generally to a method of operating an electronic device of a proximity sensing system. Aspects of the disclosure relate to a method, to a control system, to an electronic device and to a proximity sensing system.

### BACKGROUND

Proximity sensing systems are known that make use of wireless communication technologies, such as Bluetooth®, Infrared, Wi-Fi, and Ultrawide band technologies, for detecting contact events, where two or more monitored individuals meet within a threshold proximity of one another.

In such systems, the monitored individuals carry respective electronic user devices each incorporating a wireless communication system, such as a set of Bluetooth® transmitters and receivers, configured to scan for, and to periodically output, low energy advertisement signals. Detected advertisement signals can be used to identify nearby devices and the signal strength of the signals can be used to infer the proximity of the respective users carrying the devices.

In this manner, the proximity sensing systems are able to determine the proximity of the respective device users, and the duration of the contact event. The information can be recorded and used for various advantageous purposes, including workflow management, contact tracing, for example in disease outbreaks, and patient-level costing in hospitals. The proximity sensing systems may also be used to encourage social distancing, for example by providing notifications when social distancing protocols are being breached.

In many such applications, it is critically important to minimise the risk of unobserved contact events and so the electronic devices are typically configured to output advertisements frequently. However, an issue that affects proximity sensing systems of the type described above is that the battery life of the electronic device is quickly consumed, requiring regular charging or battery replacement.

It is against this background that the disclosure has been devised.

### SUMMARY OF THE DISCLOSURE

According to an aspect of the present disclosure there is provided a method of operating an electronic device in a proximity sensing system. The electronic device comprises a motion sensor for monitoring the motion of the electronic device and a wireless communication system for communication with one or more other electronic devices of the proximity sensing system. The method comprises: scanning for communication signals transmitted to the wireless communication system from another electronic device; transmitting communication signals from the wireless communication system for detection by another electronic device; and when one or more communication signals are received from another electronic device, determining a proximity of (users of) the respective electronic devices based on the one or more received communications signals. The method further comprises optimising power usage of the wireless communication system according to the motion of the electronic device by: detecting a change of the motion of the electronic device from a first motion state to a second motion state; and modifying the transmission of communication signals from the wireless communication system in dependence on the detected change.

Advantageously, the method therefore adjusts the transmission of communication signals from the electronic device as the individual carrying the device (i.e. the user of the device) changes their state of motion. For example, when the device user reduces their movements or otherwise comes to a standstill, the method saves electrical power by interrupting signal transmission or otherwise reducing the rate of signal transmission or the power of the transmitted signals. Conversely, when the device user increases their movements, for example by moving from a standstill, or starting to run, the method may increase the rate or power of signal transmission so as to provide adequate detection of other electronic devices. In this manner, the method optimises the power usage of the electronic device to reducing the battery charging or replacement requirements of the electronic device whilst ensuring that effective contact tracing can be provided.

The solution makes advantageous use of the fact that at least one device user must move towards the other device user in order to change the proximity of the electronic devices. Hence, whilst one device user remains stationary, or in a substantially constant position, and therefore less likely to enter the vicinity of another device user, the power consumption of their electronic device can be reduced, for example by deactivating a transmitter of the wireless communication system, without compromising the ability of the proximity sensing system to detect user interactions.

In an example, modifying the transmission of communication signals from the wireless communication system comprises modifying an activation state of a transmitter of the wireless communication system. More generally though, modifying the transmission of communication signals from the wireless communication system may comprise interrupting, terminating, or initiating the transmission of communication signals

In an example, modifying the transmission of communication signals from the wireless communication system may additionally, or alternatively, comprise modifying: a rate of transmission of communication signals from the wireless communication system; and/or a power of the communication signals transmitted from the wireless communication system.

The change from the first motion state to the second motion state may, for example, comprise: a reduction of the motion of the electronic device from a first motion value to a second motion value; and/or a reduction of the motion of the electronic device below a motion threshold associated with the second motion state. For example, the change from the first motion state to the second motion state may comprise a reduction in the velocity of the electronic device.

The method may, for example, further comprise: detecting a subsequent change in the motion of the electronic device; and cancelling the modification in dependence on the subsequently detected change being a change from the second motion state back to the first motion state.

In an example, the transmission of communication signals from the wireless communication system may, for example, be modified to reduce power usage of the wireless communication system.

Optionally, the power usage of the wireless communication system may be reduced by interrupting the transmission of communication signals from the wireless communication system, for example by deactivating the transmitter of the wireless communication system. Accordingly, upon cancelling the modification, the transmission of communication signals from the wireless communication may be resumed, for example by re-activating the transmitter.

Optionally, the transmission of communication signals from the wireless communication system may be modified for a predetermined period before cancelling the modification.

In an example, the method may further comprise: recording respective timestamps for a start and an end of a period of modification; and in dependence on receiving one or more communication signals from another electronic device during the period of modification: outputting the recorded timestamps and the determined proximity of the users of the respective electronic devices to allow for data reconciliation of the other electronic device. For example, the recorded timestamps and the determined proximity of the users of the respective electronic devices may be output as a proximity data record to the other device or to a central database, which detects, in turn, that the other electronic device lacks a corresponding proximity data record (due to the modified transmission of communication signals) and relays the proximity data record to the other electronic device for data reconciliation.

Optionally, the motion threshold corresponds to a stationary condition of the electronic device. Optionally, the motion threshold corresponds to a stationary condition of the electronic device being maintained for at least a threshold duration.

In an example, detecting the change from the first motion state to the second motion state comprises: determining a motion signal indicative of the motion of the electronic device; determining a motion value representing the motion of the electronic device based on the motion signal; and comparing the determined motion value to a motion threshold value of the motion threshold.

Optionally, the motion signal may comprise an acceleration measurement determined by an accelerometer of the motion sensor and a rotation measurement determined by a gyroscope of the motion sensor. The method may further comprise determining the motion value in a normalised form using the acceleration measurement and the rotation measurement. For example, the acceleration measurement and the rotation measurement may be processed to determine an orientation of the electronic device and the motion value may be determined by removing the acceleration due to gravity. The motion value may, for example, be determined using a Mahony algorithm and/or a Madgwick algorithm.

In an example, the proximity of the users of the respective electronic devices may be determined based, at least in part, on a received signal strength indication of the one or more received communication signals.

Optionally, the method may further comprise detecting a contact event when the proximity of the users of the respective electronic devices is within a proximity threshold. In this manner, the method may operate the electronic device to support social distancing.

Optionally, the method may further comprise notifying the user of the electronic device in response to detecting the contact event. In this manner, the method may operate the electronic device to support social distancing by notifying an individual when a social distance provision is breached.

The communication signals may, for example, be transmitted on at least one of the following communication channels: Bluetooth® low energy; Infrared; Wi-Fi; and/or Ultrawide band.

According to another aspect of the disclosure there is provided a control system for an electronic device of a proximity sensing system. The electronic device comprises a motion sensor for monitoring the motion of the electronic device and a wireless communication system for communication with one or more other electronic devices of the proximity sensing system. The control system is configured to execute instructions to: scan for communication signals transmitted to the wireless communication system from another electronic device; transmit communication signals from the wireless communication system for detection by another electronic device; and when one or more communication signals are received from another electronic device, determine a proximity of users of the respective electronic devices based on the one or more received communications signals. The control system is further configured to execute instructions to optimise power usage of the wireless communication system according to the motion of the electronic device by: receiving a motion signal indicative of the motion of the electronic device; detecting a change of the motion of the electronic device from a first motion state to a second motion state based on the motion signal; and modifying the transmission of communication signals from the wireless communication system in dependence on the detected change.

Optionally, the control system may comprise a motion sensing module for converting the motion signal into one or more motion values representing the motion of the electronic device and detecting the change from the first motion state to the second motion state based, at least in part, on the one or more motion values.

Optionally, the control system may comprise a proximity sensing module for determining the proximity of the detected electronic devices based, at least in part, on a received signal strength indication of the one or more received communication signals.

Optionally, the control system may comprise a memory storage module for recording the detected change, the modified transmission of communication signals, the one or more communication signals received from the other electronic device, and/or the determined proximity of the other electronic device.

According to another aspect of the disclosure there is provided an electronic device for a proximity sensing system, the electronic device comprising a control system as described in a previous aspect of the disclosure.

Optionally, the electronic device may take the form of, or otherwise be incorporated into, a wearable device. For example, the wearable device may be an item of personal protection equipment.

According to a further aspect of the disclosure there is provided a proximity sensing system for contact tracing comprising one or more electronic devices as described in a previous aspect of the disclosure.

### BRIEF DESCRIPTION OF THE DRAWINGS

Examples of the disclosure will now be described with reference to the accompanying drawings, in which:

FIG. 1 shows an exemplary proximity sensing environment in which embodiments of the disclosure may be employed;

FIG. 2 shows a schematic view of an exemplary electronic device of the proximity sensing system shown in FIG. 1;

FIG. 3 shows the steps of an example method of operating the electronic device shown in FIG. 2;

FIG. 4 shows exemplary sub-steps of the method shown in FIG. 3;

FIG. 5 shows the steps of another example method of operating the electronic device shown in FIG. 2; and

FIG. 6 shows exemplary sub-steps of the method shown in FIG. 5.

### DETAILED DESCRIPTION

Embodiments of the disclosure relate to a method, and to a control system, for operating an electronic device of a proximity sensing system to detect the proximity of individuals carrying such devices, i.e. respective electronic device users, with optimised power usage.

The electronic device of the proximity sensing system includes a wireless communication system, such as a set of Bluetooth® transmitters and receivers, configured to scan for, and to (periodically) transmit, communication signals in the form of advertisements. By scanning for such advertisements, the electronic device can detect, and identify, nearby electronic devices and analyse the signal strength of the detected advertisements to infer the proximity of the respective users carrying the devices. In this manner, contact events may be detected, where two or more individuals carrying respective electronic devices meet within a threshold proximity of one another. For example, a contact event may be detected by comparison to a proximity threshold and/or by determining whether the individuals have been in sufficiently close contact for longer than a threshold period of time.

The electronic device also includes a motion sensor for monitoring the motion of the electronic device and, advantageously, the method optimises the power usage of the electronic device by: determining a motion signal that is indicative of the motion of the electronic device; detecting a change in the motion of the electronic device from a first motion state to a second motion state based on the motion signal; and modifying the transmission of communication signals from the wireless communication system in dependence on the detected change. For example, if a device user enters a room and sits down, the motion signal will indicate that the electronic device has changed to a stationary state and, in response to the change, the power usage of the electronic device may be reduced by interrupting the transmission of communication signals from the wireless communication system.

Here, the method makes advantageous use of the fact that at least one device user must move towards the other device user in order to change the proximity of the respective electronic devices. The likelihood of a first individual moving into the vicinity of a second individual reduces as the first individual becomes less active, or maintains a substantially constant position, and so the transmission of communication signals from the electronic device can be modified to save power, for example by deactivating the transmitter. Nonetheless, the ability of the proximity sensing system to detect contact events between the two individuals is uncompromised as the electronic device carried by the first individual continues to scan for advertisements transmitted from other electronic devices that may move towards the first individual and thereby change the proximity of the respective electronic devices.

It is anticipated that the method will prolong the battery life of the electronic devices, reducing power charging or battery replacement requirements, and ultimately leading to enhanced coverage, or detection, of instances of contact between device-carrying individuals.

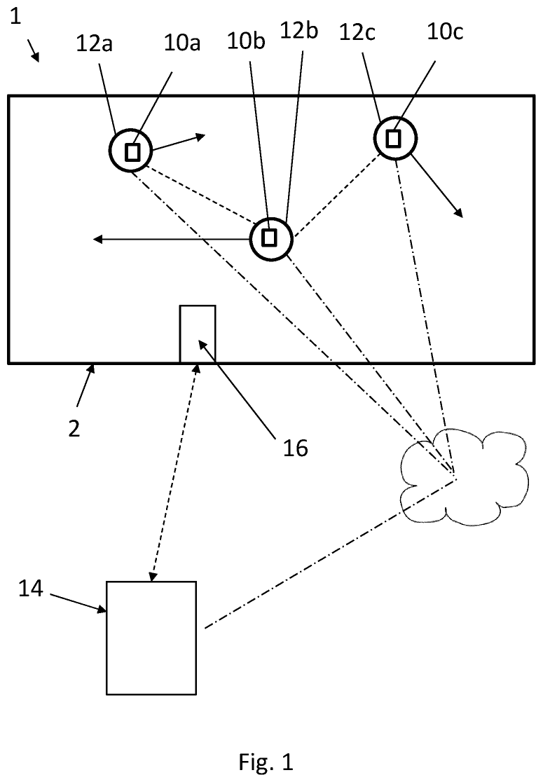

FIG. 1 schematically illustrates an example proximity sensing system 1 for detecting the proximity of monitored individuals in an environment 2.

In this case, the proximity sensing system 1 is one that could be used to support social distancing within a workplace, for example. For this purpose, the proximity sensing system 1 includes a plurality of electronic devices 10a-c, each being carried by a respective user 12a-c and adapted for sensing the close presence of other electronic devices 10a-c through a suitable technology, such as short-range wireless. For example, each of the plurality of electronic devices 10a-c may include a wireless communication system for transmitting and receiving communication signals containing identifiers of the respective electronic device 10a-c. The communication signals may, for example, take the form of advertisements and are referred to as such in the following description.

The electronic devices 10a-c may be devices that are specifically developed for sensing the close presence of other electronic devices 10a-c, or they may be dual purpose devices with another function in the environment (for example, a user's security pass, which also serves to open doors within the environment). They may also be general-purpose computing or communication devices—such as a user's mobile telephone—running a suitable application, and accessing hardware already present in the general-purpose device. Furthermore, for convenient monitoring, each electronic device 10a-c may for example, take the form of, or be incorporated into, a wearable device, such as an item of personal protection equipment, which may be particularly suited to proximity sensing in a healthcare environment, for example.

In FIG. 1, the plurality of electronic devices 10a-c is shown to include a first electronic device 10a, a second electronic device 10b, and a third electronic device 10c, that interact over appropriate network connections with a cloud service 14 that can provide analysis and reporting over the assemblage of electronic devices 10a-c. This is shown here as reporting back to a site server 16 which provides reporting for a site. However, other computing architectures are possible and this example is not intended to be limiting. For example, the proximity sensing system 1 may include any number of electronic devices in other examples.

When one of the electronic devices, such as the first electronic device 10a, moves within range of another one of the electronic devices, such as the second electronic device 10b, each of the first and second electronic devices 10a, 10b can detect the respective advertisements transmitted from the other electronic device 10a, 10b and thereby identify that electronic device 10a, 10b based on the respective device identifier. The electronic devices 10a, 10b are further configured to measure the signal strength of the received advertisements and thereby to determine the proximity of the detected electronic device 10a, 10b, for example based on a received signal strength indication (RSSI) of the advertisements.

In this manner, when two or more device-carrying individuals meet, the proximity sensing system 1 is able to determine the proximity of the respective electronic devices 10a-c, and the duration of the contact between the individuals, which can be recorded and used for various advantageous purposes.

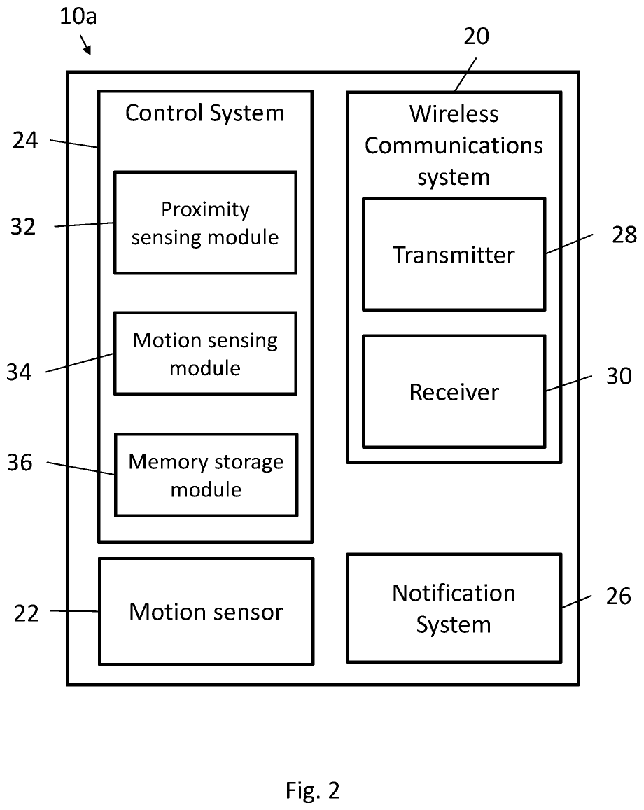

To minimise the risk of unobserved devices or contact events, each electronic device 10a-c may be configured to transmit the advertisements periodically, for example at a rate, or frequency, that is optimised for adequate contact detection. However, as the rate of transmission increases, more power is consumed, which can compromise the battery life of the electronic device 10a-c and ultimately require frequent charging or battery replacement. To mitigate this issue, the present proximity sensing system 1 is advantageously configured to optimise power usage of at least one of the electronic devices 10a-c, without compromising the ability to detect nearby devices, using motion data obtained from motion sensors incorporated into that electronic device 10a-c, as shall now be described in more detail with reference to FIG. 2.

FIG. 2 illustrates a non-limiting example of the first electronic device 10a.

For the sake of clarity, the second and third electronic devices 10b, 10c of the proximity sensing system 1 may be substantially identical to the first electronic device 10a, and include a motion sensor for power usage optimisation, or they may take any suitable form for wireless proximity sensing, incorporating a wireless communication system for transmitting and receiving communication signals (in the form of advertisements) containing device identifiers as described above.

As shown in FIG. 2, the first electronic device 10a may include a wireless communication system 20, a motion sensor 22, a control system 24 and a notification system 26.

The wireless communication system 20 may be substantially as described above and is operable by the control system 24 to transmit advertisements for detection by the other electronic devices 10b, 10c and to scan for counterpart advertisements transmitted from the other electronic devices 10b, 10c. The advertisements may be transmitted on any suitable communication channel, including a Bluetooth® low energy, an Infrared, a Wi-Fi, and/or an Ultrawide band, communication channel. For this purpose, the wireless communication system 20 may include one or more transmitters 28 and one or more receivers 30, such as Bluetooth® Low energy transmitters and receivers, as shown in FIG. 2.

The motion sensor 22 is advantageously incorporated into the first electronic device 10a for monitoring the motion of the electronic device 10a, and thereby inferring the motion of the respective user 12a.

The motion sensor 22 may take various suitable forms for this purpose and may, for example, include one or more gyroscopes, magnetometers, and/or accelerometers, such as a microelectromechanical accelerometer. The motion sensor 22 is configured to measure the motion of the first electronic device 10a and to output a motion signal to the control system 24 that is indicative of the motion of the first electronic device 10a. The motions signal may, for example, comprise time-varying sensor data, including an acceleration of the first electronic device 10a in one or more directions, a rotation of the first electronic device 10a, and/or a magnetic field detected by the magnetometer.

In this manner, the motion signal can be analysed by the control system 24 to detect changes in the motion of the first electronic device 10a and, in turn, the respective device user 12a. For example, by virtue of the onboard motion sensor it is possible to detect when the device user 12a stops moving, or takes a seat in a chair, and becomes substantially stationary.

The control system 24 is configured to control the wireless communication system 20 for proximity sensing. In particular, the control system 24 is configured to control the scanning for advertisements, performed by the receiver(s) 30 of the wireless communication system 20, and the transmission of advertisements from the transmitter(s) 28 of the wireless communication system 20.

When one or more advertisements are received from another electronic device, such as the second electronic device 10b, the control system 24 is also configured to determine the proximity of the detected electronic device 10b. In examples, the control system 24 may be configured to quantify the proximity, for example as an estimate of the distance between the first electronic device 10a and the detected electronic device 10b, and/or to estimate a binary outcome, such as whether or not a contact event has occurred, by estimating whether the proximity of the detected electronic device 10b is within a proximity threshold (i.e. estimating whether or not a physical distance between the first electronic device 10a and the detected electronic device 10b is less than a specified distance threshold).

For this purpose, the control system 24 may include a proximity sensing module 32 configured to determine the proximity of the detected electronic device 10b based on the one or more received advertisements. The proximity sensing module 32 may determine the proximity based, at least in part, on a received signal strength indication, RSSI, of the one or more received advertisements, for example. However, noise and interference can have a significant impact on the properties of the received advertisement(s), including the RSSI of such signals. Hence, for accurate proximity sensing, the proximity sensing module 32 may be programmed to execute one or more proximity estimation algorithms or techniques for analysing the RSSI of the received advertisement(s) and determining the proximity of the detected electronic device 10b. For example, the proximity sensing module 32 may include a machine learning algorithm developed from existing data. The machine learning algorithm may be implemented as a support vector machine, decision tree, random forest, convolutional neural network, long-short term memory network, or another form of artificial neural network. Such an algorithm may also comprise features such as thresholding, averaging, weighted averaging, and/or Kalman filtering in order to produce reliable results. The algorithm may further use regression, such as linear regression, for quantifying the proximity of the detected electronic devices 10b (e.g. as a distance in centimetres), and/or logistic regression, for estimating a binary outcome (such as the detection of a contact event, i.e. whether or not the distance between the first and second electronic devices 10a, 10b is less than a specified threshold).

Advantageously, the control system 24 is also configured to receive the motion signal from the motion sensor 22 and to optimise the power usage of the wireless communication system based on changes in the motion of the device user 12a that are indicated by the motion signal.

For example, the control system 24 may be configured to receive the motion signal, to detect a change in the motion of the first electronic device 10a and to modify the transmission of advertisements from the wireless communication system 20 accordingly. In this manner, upon detecting that the first electronic device 10a has become stationary or less active, the control system 24 may reduce or interrupt the transmission of advertisements, thereby reducing the power usage of the first electronic device 10a, until the first electronic device 10a starts moving again. The battery life of the first electronic device 10a can be prolonged by such modifications and, as shall be explained in more detail below, the ability to detect contact with other device users 12b, 12c can remain uncompromised.

For the purpose of analysing the motion signal and detecting changes in the motion of the first electronic device 10a, the control system 24 may include a motion sensing module 34 comprising one or more motion processing algorithms or techniques for determining motion values representing the motion of the electronic device 10a along one or more axes of movement. For example, the motion sensing module 34 may include an algorithm for normalising raw acceleration data obtained from the motion sensor 22 to remove the measurement of acceleration due to gravity. Such an algorithm may, for example, include a Mahony algorithm and/or a Madgwick algorithm or a variant thereof, applied to accelerometer, gyroscope and magnetometer data, or applied to a subset of these sensor types. In this manner, the control system 24 may determine the magnitude and/or direction of the movements of the first electronic device 10a, which may be used to detect whether the motion of the electronic device 10a has changed.

In examples, the control system 24 may be configured to modify the transmission of advertisements in dependence on the motion of the first electronic device 10a changing from a first motion state to a second motion state. For example, the change from a first motion state to a second motion state may take the form of a reduction, or an increase, in the motion of the electronic device 10a from a first motion value to a second motion value. In other examples, the change from the first motion state to the second motion state may alternatively, or additionally, be a binary determination made by comparison to a motion threshold. For example, the motion threshold may be calibrated for a stationary condition, allowing for certain movements of the first electronic device 10a, providing that a substantially constant position is maintained. The motion threshold may therefore allow for limited movement within the confines of a geographical area, such as a room, or shuffling within a seat, for example. In this case, the change from the first motion state to the second motion state may be detected when the device user 12a stops, or starts, moving and the control system 24 may be configured to compare the motion signals, or any motion values derived therefrom, to the motion threshold to detect the change.

The control system 24 is configured to modify the transmission of advertisements from the wireless communication system 20 based on the detected motion changes in order to optimise the power usage of the first electronic device 10a. In particular, when it is determined that the motion of the first electronic device 10a has changed from the first motion state to the second motion state, the control system 24 is configured to modify the transmission of advertisements accordingly. For example, the control system 24 may change: an activation state of one or more of the transmitter(s) 28; a rate of transmission of advertisements from the wireless communication system 20; and/or a signal power of the advertisements transmitted.

In this manner, when the control system 24 determines that the motion of the electronic device 10a has reduced from the first motion state to the second motion state, the control system 24 may modify the transmission of advertisements from the wireless communication system 20 to reduce the power usage. For example, the control system 24 may deactivate the transmitter(s) 28, and thereby interrupt the transmission of communication signals from the wireless communication system 20 for a predetermined period or until a further change, such as an increase, in the motion of the electronic device 10a is detected. In an example, if the control system 24 subsequently determines that the motion of the electronic device 10a has increased again from the second motion state back to the first motion state, the control system 24 may be configured to subsequently reverse or cancel the modification, restoring the prior transmission of advertisements. For example, the control system 24 may reactivate the transmitter(s) 28, and resume the transmission of advertisements

The control system 24 may also include a memory storage module 36 comprising a contact database for storing records of detected advertisements, and/or electronic devices 10b, 10c, including the device identifier, the determined proximity of that electronic device 10b, 10c, and a timestamp associated with the detected contact. The memory storage module 36 may also be configured to store records of any power saving operations or modifications to the advertisement transmission from the first electronic device 10a, including, for example, the motion data, a start time of the modification, an end time of the modification, and details of the modification made, i.e. the manner of modification to the transmission of advertisements.

As shall be described in more detail, the memory storage module 36 may interact over appropriate network connections with the cloud service 14 for providing updates, corrections, or additions to the contact database. For example, the wireless communications system 20 may connect to the site server 16 to provide data consolidation of contact events.

For the purpose of receiving and/or storing such data, the memory storage module 36 may take the form of a computer-readable storage medium (e.g., a non-transitory computer-readable storage medium). The computer-readable storage medium may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

The notification system 26 is an optional system of the electronic device 10a that is operable by the control system 24 to notify the respective user 12a when contact with another electronic device 10b-c is detected. For example, the notification system 26 may be operated upon detecting a contact event. In this manner, the electronic device 10a may be used as to support social distancing when a social distancing area is encroached.

The notification system 26 may take various forms for this purpose and may include any suitable device for notifying the user by means of audio, visual, and/or haptic feedback. For example, the notification system 26 may include a display screen and/or a speaker for providing visual and/or audible notification of the detected contact.

For purposes of this disclosure, it is to be understood that the functional systems, elements, and modules of the electronic device 10a described herein may each comprise a control unit or computational device having one or more electronic processors. A set of instructions could be provided which, when executed, cause said control unit(s) to implement the control techniques described herein (including the described method(s)). The set of instructions may be embedded in one or more electronic processors, or alternatively, the set of instructions could be provided as software to be executed by one or more electronic processor(s). The set of instructions may be embedded in a computer-readable storage medium (e.g., a non-transitory computer-readable storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

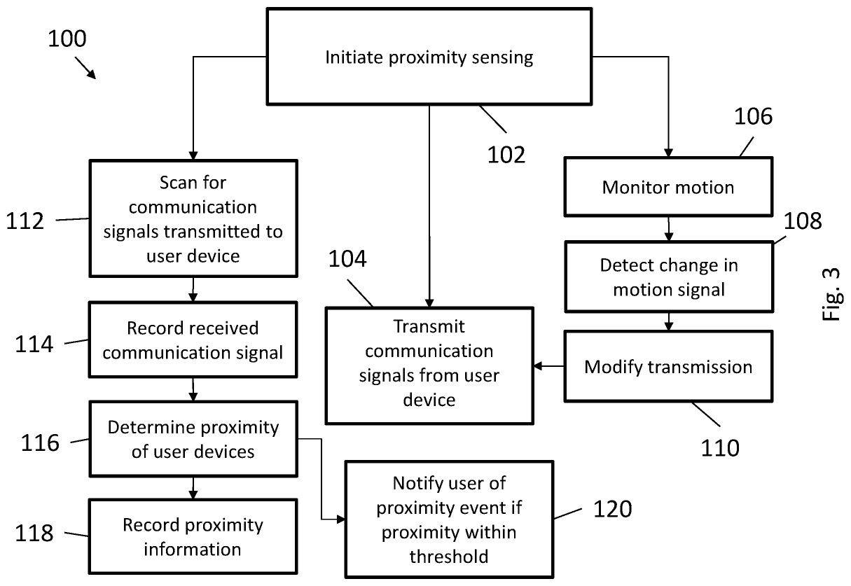

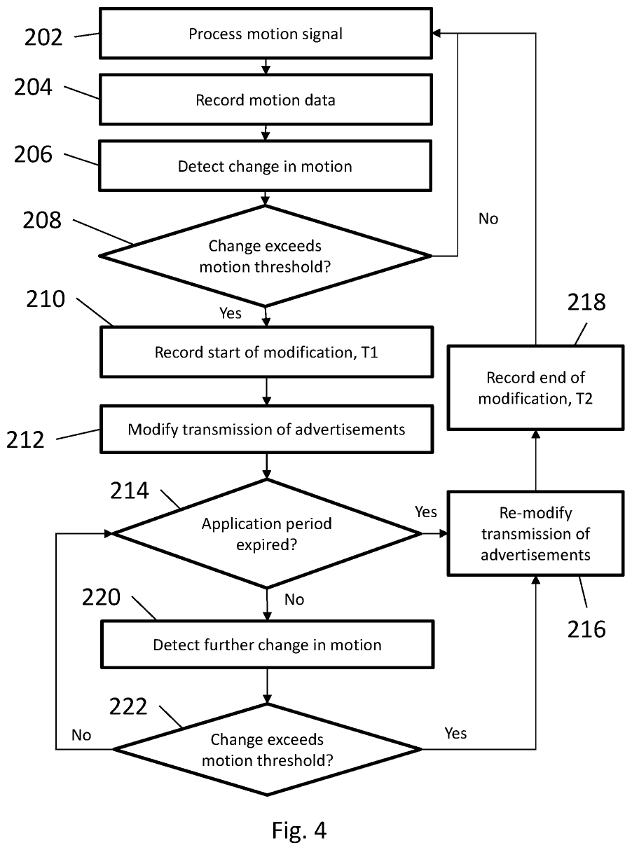

The operation of the first electronic device 10a in the proximity sensing system 1, shall now be described with additional reference to FIGS. 3 and 4.

FIG. 3 shows a broad embodiment of a method 100 of operating the first electronic device 10a in the proximity sensing system 1 to monitor interactions with the other electronic devices 10b, 10c.

In step 102, the control system 24 initiates proximity sensing and may, for example, activate the transmitter(s) 28 and receiver(s) 30 of the wireless communication system 20, as well as the motion sensor 22.

In step 104, the wireless communication system 20 transmits advertisements from the first electronic device 10a for detection by other nearby electronic devices 10b, 10c. For example, the control system 24 may operate the transmitter(s) 30 of the wireless communication system to transmit communication signals, in the form of advertisements, for detection by any electronic devices 10b, 10c within range of the first electronic device 10a.

The advertisements may be transmitted periodically and the rate of transmission, and/or the power of each advertisement signal may be controlled by the control system 24. Preferably, the advertisements may, for example, be transmitted on a Bluetooth® low energy communication channel, which is particularly effective because of its low power consumption in maintaining a broadly consistent communication range. However, in other examples, other personal area network technologies can also be used for this purpose.

While the wireless communication system 20 is transmitting advertisements, the motion sensor 22 monitors the motion of the first electronic device 10a and outputs a motion signal to the control system 24, in step 106.

The motion signal is indicative of the motion of the first electronic device 10a and may, for example, comprise time-varying sensor data, including measurements of the acceleration of the first electronic device 10a in one or more directions, as well as rotation measurements of the first electronic device 10a.

In step 108, the control system 24 analyses the motion signal to detect changes in the motion of the first electronic device 10a, such as a reduction from a first motion state to a second motion state.

In step 110, the motion information is used to optimise the power usage of the first electronic device 10a and the control system 24 may, for example, modify the transmission of advertisements from the wireless communication system 20 based on the detected changes. In this manner, the transmission of advertisements can be modified to save power when the motion of the individual 12a carrying the first electronic device 10a reduces, for example as the individual 12a becomes stationary or moves around less.

At the same time, in step 112, the wireless communication system 20 scans for advertisements transmitted from the other electronic devices 10b, 10c in order to detect any nearby electronic devices 10b, 10c.

This may be carried out as a permanent background activity while the first electronic device 10a is on, with sensing events taking place at predetermined intervals, or according to some other predetermined strategy.

Another electronic device 10b, 10c may or may not be detected in the scanning process. If no other electronic devices 10b, 10c are detected, the scanning may continue according to a predetermined pattern (this may be simply a predetermined frequency, or there may be a more complex continuation based on environment or user behaviour).

If another electronic device, such as the second electronic device 10b, is detected, the RSSI of the received advertisement(s) may be stored in the memory storage module 36 of the control system 24, in step 114, along with a timestamp, and the device identifier contained in the advertisement(s).

In step 116, the control system 24 proceeds to determine the proximity of the detected electronic device 10b, 10c, based at least in part on the RSSI of the received advertisement(s). For example, the control system 24 may apply the one or more proximity estimation algorithms for quantifying the proximity of the detected electronic device 10b based on the RSSI and determining whether the distance between the first electronic device 10a and the detected electronic device 10b is less than the distance threshold.

If the proximity estimation algorithms indicate that a contact event occurred—in other words, that the electronic devices 10a, 10b are determined to be within a certain proximity threshold,—the contact event may be stored in the memory storage module 36, in step 118. The contact event here comprises a timestamp, together with a suitable variable to indicate that the event occurred (e.g. an integer value of ‘1’ may indicate that a contact event has occurred).

In step 120, the control system 24 may then operate the notification system 26 to alert the user 12a of the first electronic device 10a of the contact event and thereby warn the user 12a that social distancing protocols are being breached, for example.

In this manner, the power usage of the electronic device 10a can be modified according to the motion of the device user 12a, allowing for power saving and a prolonged battery life, whilst effectively supporting social distancing to reduce the transmission of infectious disease.

FIG. 4 shows an exemplary implementation of such a method, and particularly the broadly defined steps of monitoring the motion of the first electronic device 10a (step 106), detecting changes in the motion of the first electronic device 10a (step 108) and modifying the transmission of advertisements therefrom (step 110), in detail.

First, in step 202, the control system 24 receives the motion signal and processes the motion signal to quantify the motion of the first electronic device 10a. In particular, the control system 24 may operate the motion sensing module 34 and apply the one or more motion processing algorithms for converting the raw sensor data into usable motion values. For example, where the motion sensor 22 includes a microelectromechanical accelerometer and a gyroscope, the raw accelerometer data may be normalised to remove the measurement of acceleration due to gravity. For example, the control system 24 may use a Mahony algorithm and/or a Madgwick algorithm, applied to the accelerometer and gyroscope data.

Here, the accelerometer may provide time-varying acceleration measurements for the first electronic device 10a along three orthogonal accelerometer axes. The gyroscope may provide corresponding time-varying rotation measurements of the first electronic device 10a. The sensor data from the gyroscope and accelerometer may be collated and analysed to produce an estimated orientation of the electronic device 10a, which may be expressed in quaternions.

In which case, the control system 24 may apply a matrix conversion algorithm to convert the orientation measurements from quaternions to angles, measured in degrees, relative to each of the accelerometer axes. By way of example, the quaternion can be converted into a Rotation Matrix, or another suitable conversion may be performed for this purpose.

The control system 24 may then calculate the acceleration due to gravity for each accelerometer axis by multiplying the gravity vector by the Rotation Matrix, and thereby projecting the force of gravity onto the three accelerometer axes. The acceleration due to gravity may then be subtracted from the raw accelerometer data for each accelerometer axis, leaving the acceleration due to the actual motion of the first electronic device 10a.

In an example, the control system 24 may then transpose the acceleration vectors onto a global reference frame by multiplying the acceleration values for each accelerometer axis by the transpose of the Rotation Matrix.

In this manner, the motion of the electronic device 10a can be quantified as one or more time-varying motion values and, in step 204, the control system 24 may record the motion data along with any contact events, or proximity data, obtained in steps 112 to 118.

In steps 206 and 208, the control system 24 analyses the quantified motion data to detect a change in the motion of the first electronic device 10a from a first motion state to a second motion state.

By way of example, the change in the motion of the first electronic device 10a from the first motion state to the second motion state may correspond to change from a mobile state to a stationary state, and the change may be detected by comparing the motion values to a motion threshold corresponding to the stationary state.

While the motion values remain above the motion threshold, the motion signal may indicate that the device user 12a is still in significant motion and so the motion of the electronic device 10a may be monitored further, according to steps 202 to 208, until the motion values fall below the motion threshold. When the motion values fall below the motion threshold, the motion signal indicates that the electronic device 10a has become stationary and that the transmission of advertisements should be adapted accordingly.

Hence, in step 210, the control system 24 records the detected change from the mobile state to the stationary state in the memory storage module 36, along with a respective timestamp for the start of a modification period. Here, the start of the modification period is the start of a period during which the transmission of advertisements is modified to optimise the power usage of the electronic device 10a, as shall be described in more detail in the following steps.

In particular, in step 212, the control system 24 proceeds to modify the transmission of advertisements from the wireless communication system 20 based on the detected change from the first motion state to the second motion state. Since the motion of the first electronic device 10a has reduced from the mobile state to the stationary state, the likelihood of the first electronic device 10a entering the vicinity of another electronic device 10a is significantly reduced and so power can be saved by modifying the transmission of advertisements accordingly. For example, the control system 24 may execute instructions corresponding to the detected change from the mobile state to the stationary state and deactivate one or more of the transmitter(s) 28 to interrupt the transmission of further advertisements. In doing so, the power usage of the first electronic device 10a is significantly reduced but the first electronic device 10a continues to scan for nearby devices 10b, 10c, in step 112. Hence, the first electronic device 10a is able to detect when another electronic device, such as the second electronic device 10b, is moved towards the first electronic device 10a and to notify the user 12a accordingly, as described in steps 112 to 120, thereby supporting social distancing.

The control system 24 may, for example, modify the transmission of advertisements in this manner for a predetermined application period and, in step 214, the control system 24 may check whether that application period has elapsed from the start of the modification period, T1.

If the application period has elapsed, the control system 24 may cancel the modification, in step 216, and restore the ordinary, or prior, transmission of advertisement signals. For example, the control system 24 may re-activate the transmitter(s) 28 and resume the ordinary transmission of advertisements.

The end of the modification period, T2, is then recorded in the memory storage module 36, in step 218, along with the modification applied and any contact events, or proximity data, detected through steps 112 to 118, during the modification period. The method 100 then proceeds to further monitor the motion of the electronic device 10a, in step 202.

If the application period has not yet elapsed, in step 214, the control system 24 proceeds to monitor the motion of the electronic device 10a further, in step 220, to detect any further changes in the motion of the electronic device 10a. For example, the control system 24 may monitor the motion of the electronic device 10a, substantially as described in steps 202 to 208, to detect a further change in the motion of the first electronic device 10a from the second motion state back to the first motion state. In other words, the control system 24 may analyse the subsequent motion of the first electronic device 10a to detect whether or not the first electronic device 10a starts moving again.

If the motion of the first electronic device 10a changes from the second motion state to the first motion state, in step 222, the control system 24 may proceed to cancel the modification, as described in step 216, and to record the end of the modification period, as described in step 218.

Otherwise, the control system 24 may continue to check whether the application period has elapsed, in step 214, and to monitor the subsequent motion of the electronic device 10a in a loop according to step 220.

In this manner, upon detecting changes in the motion of the first electronic device 10a, the control system 24 may temporarily modify the transmission of advertisements to save power, whilst ensuring that contact events are detected and continuing to support social distancing.

In other examples, the change in the motion of the first electronic device 10a from the first motion state to the second motion state may simply correspond to a decrease in the motion of the electronic device 10a and power may be saved by adapting the transmission of advertisements in a similar manner, or otherwise reducing the rate of transmission of advertisements and/or a signal power of each transmitted advertisement. Furthermore, in other examples, the change in the motion of the first electronic device 10a from the first motion state to the second motion state may correspond to an increase in the motion of the electronic device 10a and the rate of transmission of advertisements and/or the signal power of each transmitted advertisement may be temporarily increased to offer adequate detection of nearby electronic devices 10b, 10c.

As a result of the method 100, it is envisaged that the battery life of the first electronic device 10a will be prolonged, with longer intervals between charges and/or battery replacement, allowing for more convenient proximity sensing.

The proximity sensing system 1 is therefore applicable to various applications and may, for example, be deployed in a workflow management application, for contact tracing, or for patient-level costing in a hospital environment.

It is noted that the steps of the method 100 are only provided as a non-limiting example of the disclosure, and many modifications may be made to the above-described examples without departing from the scope of the appended claims.

For example, it shall be appreciated that, during a modification period, when the transmission of advertisements from the first electronic device 10a is temporarily interrupted or otherwise reduced, a contact event between the first and second electronic devices 10a, 10b will be detected at the first electronic device 10a, but the contact event may not be detected at the second electronic device 10b.

Hence, in another example method 300 of operating the electronic device 10a, data consolidation may also be performed via the network connection to the cloud service 14.

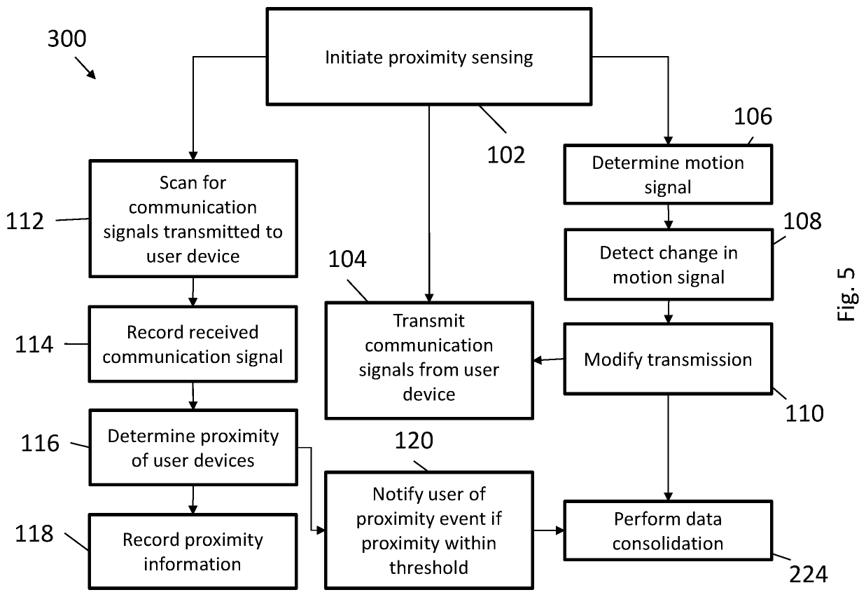

For example, as shown in FIG. 5, the method 300 may proceed through steps 102 to 120, substantially as described in the method 100 of FIG. 3, and further include data consolidation, in step 224.

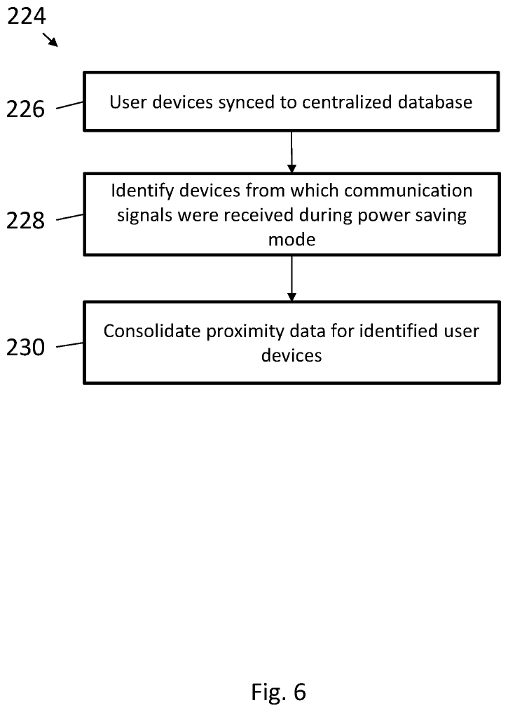

By way of example, FIG. 6 shows example steps of the data consolidation that may be performed in step 224.

In step 226, the plurality of electronic device 10a-c may interact over the network connections to the cloud service 14 and sync data to the site sever 16, including the modification data for any modification periods and any contacts events detected during such modification periods.

In step 228, the site server 16 identifies any electronic devices 10a-c from whom an advertisement was received during a modification period of another electronic device 10a-c. In other words, the site server 16 may identify when the first electronic device 10a was not transmitting advertisements but detected an advertisement from the second electronic device 10b. In this situation, the contact database of the second electronic device 10b does not contain a record of the proximity to the first electronic device 10a, despite being in proximity, as the first electronic device 10a may not have been transmitting advertisements during the modification period.

In step 230, the contact databases of the electronic devices 10a-c are updated to account for the missing data in a data reconciliation process. Continuing the example given above, the second electronic device 10b will receive the data concerning the modification period of the first electronic device 10a, including the start and end timestamps for the modification period, and the data concerning the detected advertisements from the second electronic device 10b during the modification period.

As there can be multiple modification periods for different devices 10a-c, this process is repeated for each modification period and for each electronic device 10a-c. The process is also conducted for modification periods during which advertisement transmission from two or more of the electronic devices 10a-c is modified, where the electronic devices 10a-c are known to be in proximity of one another, as may be evident from the proximity data established immediately before the electronic devices 10a-c entered the modification period.

After data reconciliation is complete, the data can be used for a variety of applications. For example, the technology can facilitate contact tracing, in order to identify individuals at risk of contracting an infectious disease, due to close proximity to an infected individual. In addition, the proximity data can help to characterize hospital workflow, understand the efficiency and duration of patient interactions, and characterize the cost of caring for different patient subgroups.

In the embodiment described, data syncing occurs at step 224, however in other embodiments of the proximity sensing system 1, the data syncing can occur at any step of the method 300.

In another example, the control system 24 may be configured to detect one or more specific acts of movement, or motion gestures, performed by the user 12a carrying the electronic device 10a using the motion data determined by the motion sensor 22.

Such movements may, for example, include steps of the device user 12a whilst walking or running, which may be detected using one or more known methods, algorithms, or techniques for motion modelling, or gait analysis, that may be incorporated into the control system 24. Such motion modelling algorithms and techniques are not described in detail here but may, for example, include the use of a gait profile, associated with a walking, or running, step of the user 12a, that may be compared to the motion signal, or any motion values derived therefrom, for step detection. Similar motion modelling algorithms and techniques of this type are commonly employed for step counting purposes in known pedometer devices.

The motion modelling algorithms may be pre-programmed by the manufacturer or otherwise determined, or refined, by machine learning algorithms of the control system 24 that may be trained based on labelled datasets and/or a physics/mechanics-based model of human motion.

The control system 24 may be further configured to use the detected movements to detect and/or label the motion state of the electronic device 10a, or the respective device user 12a. For example, the control system 24 may detect a succession of steps, indicating a walking state of the user 12a, and the subsequent absence of such step detections may lead the control system 24 to determine a change to a standing state of the user 12a. In this manner, the step detection may provide another form of motion threshold that may be used to detect a change from a first motion state to a second motion state.

In such examples, the motion sensor 22 may also serve as a pedometer and the control system 24 may be configured to determine a step count of the respective user 12a based on the motion signal. The step count may be stored in the memory storage module 36 and later presented to the user 12a or otherwise used to determine the motion state of the electronic device 10a.

1. A method of operating an electronic device in a proximity sensing system, the electronic device comprising a motion sensor for monitoring the motion of the electronic device and a wireless communication system for communication with one or more other electronic devices of the proximity sensing system, the method comprising:
scanning for communication signals transmitted to the wireless communication system from another electronic device;
transmitting communication signals from the wireless communication system for detection by another electronic device; and
when one or more communication signals are received from another electronic device, determining a proximity of users of the respective electronic devices based on the one or more received communications signals;
the method further comprising optimising power usage of the wireless communication system according to the motion of the electronic device by:
detecting a change of the motion of the electronic device from a first motion state to a second motion state; and
modifying the transmission of communication signals from the wireless communication system in dependence on the detected change.

2. The method according to claim 1, wherein modifying the transmission of communication signals from the wireless communication system comprises modifying an activation state of a transmitter of the wireless communication system.

3. The method according to claim 1, wherein modifying the transmission of communication signals from the wireless communication system comprises modifying:
a rate of transmission of communication signals from the wireless communication system; and/or
a power of the communication signals transmitted from the wireless communication system.

4. The method according to claim 1, wherein the change from the first motion state to the second motion state comprises:
a reduction of the motion of the electronic device from a first motion value to a second motion value; and/or
a reduction of the motion of the electronic device below a motion threshold associated with the second motion state.

5. The method according to claim 4, further comprising:
detecting a subsequent change in the motion of the electronic device; and
cancelling the modification in dependence on the subsequently detected change being a change from the second motion state back to the first motion state.

6. The method according to claim 4, wherein the transmission of communication signals from the wireless communication system is modified to reduce power usage of the wireless communication system.

7. The method according to claim 6, wherein the power usage of the wireless communication system is reduced by deactivating the transmitter of the wireless communication system, and thereby interrupting the transmission of communication signals from the wireless communication system.

8. The method according to claim 1, wherein the transmission of communication signals from the wireless communication system is modified for a predetermined period before cancelling the modification.

9. The method according to claim 5, further comprising:
recording respective timestamps for a start and an end of a period of modification; and
in dependence on receiving one or more communication signals from another electronic device during the period of modification:
outputting the recorded timestamps and the determined proximity of the users of the respective electronic devices to allow for data reconciliation of the other electronic device.

10. The method according to claim 4, wherein the motion threshold corresponds to a stationary condition of the electronic device.

11. The method according to claim 10, wherein the motion threshold corresponds to a stationary condition of the electronic device being maintained for at least a threshold duration.

12. The method according to claim 4, wherein detecting the change from the first motion state to the second motion state comprises:
determining a motion signal indicative of the motion of the electronic device;
determining a motion value representing the motion of the electronic device based on the motion signal; and
comparing the determined motion value to a motion threshold value of the motion threshold.

13. The method according to claim 12, wherein the motion signal comprises an acceleration measurement determined by an accelerometer of the motion sensor and a rotation measurement determined by a gyroscope of the motion sensor, and
wherein the method further comprises determining the motion value in a normalised form using the acceleration measurement and the rotation measurement.

14. (canceled)

15. The method according to claim 1, wherein the proximity of the users of the respective electronic devices is determined based, at least in part, on a received signal strength indication of the one or more received communication signals.

16. The method according to claim 15, further comprising: detecting a contact event when the proximity of the users of the respective electronic devices is within a proximity threshold; and notifying the user of the electronic device in response to detecting the contact event.

17-18. (canceled)

19. A control system for an electronic device of a proximity sensing system, the electronic device comprising a motion sensor for monitoring the motion of the electronic device and a wireless communication system for communication with one or more other electronic devices of the proximity sensing system, the control system being configured to execute instructions to:
scan for communication signals transmitted to the wireless communication system from another electronic device;
transmit communication signals from the wireless communication system for detection by another electronic device; and
when one or more communication signals are received from another electronic device, determine a proximity of users of the respective electronic devices based on the one or more received communications signals;
wherein the control system is further configured to execute instructions to optimise power usage of the wireless communication system according to the motion of the electronic device by:
receiving a motion signal indicative of the motion of the electronic device;
detecting a change of the motion of the electronic device from a first motion state to a second motion state based on the motion signal; and
modifying the transmission of communication signals from the wireless communication system in dependence on the detected change.

20. The control system according to claim 19, comprising at least one among (a) a motion sensing module for converting the motion signal into one or more motion values representing the motion of the electronic device and detecting the change from the first motion state to the second motion state based, at least in part, on the one or more motion values; and (b) a proximity sensing module for determining the proximity of the detected electronic devices based, at least in part, on a received signal strength indication of the one or more received communication signals.

21. (canceled)

22. The control system according to claim 19, comprising a memory storage module for recording the detected change, the modified transmission of communication signals, the one or more communication signals received from the other electronic device, and/or the determined proximity of the other electronic device.

23. An electronic device for a proximity sensing system, the electronic device comprising a control system according to claim 19.

24. (canceled)

25. A proximity sensing system for contact tracing comprising one or more electronic devices according to claim 23.
